(19) United States
(12) Patent Application Publication
(10) Pub. No.: US 2016/0180158 A1
(43) Pub. Date: Jun. 23, 2016

(54) VEHICLE VISION SYSTEM WITH PEDESTRIAN DETECTION

(71) Applicant: MAGNA ELECTRONICS INC., Auburn Hills, MI (US)

(72) Inventors: Nikhil Gupta, Brampton (CA); Xai Phan, Mississauga (CA)

(21) Appl. No.: 14/969,528

(22) Filed: Dec. 15, 2015

Related U.S. Application Data
(60) Provisional application No. 62/093,744, filed on Dec. 18, 2014.

(51) Int. Cl. G06K 9/00; H04N 7/18; G06T 7/20; G06K 9/62; G06T 5/00

(52) U.S. Cl. CPC G06K 9/00362; G06K 9/00805; G06K 9/6267; G06T 5/006; G06T 7/208; H04N 7/185; G06T 2207/30261; G06T 2207/30241; G06T 2207/30196

(57) ABSTRACT

A vision system of a vehicle includes a camera configured to be disposed at a vehicle so as to have a field of view exterior of the vehicle. An image processor is operable to process image data captured by the camera. The image processor, responsive to image processing of captured image data when the camera is disposed at the vehicle, is operable to determine the presence of a pedestrian in the field of view of the camera. The vision system may utilize a linear classifier to identify areas where a pedestrian is more likely to be present for enhanced processing of those areas. The vision system may utilize a Histogram Intersection Kernel classifier for enhanced processing of identified areas. The vision system may utilize detection area filtering to reduce processing of image data representative of areas of the field of view where a pedestrian is not likely to be present.

### CROSS REFERENCE TO RELATED APPLICATION

The present application claims the filing benefits of U.S. provisional application Ser. No. 62/093,744, filed Dec. 18, 2014, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

The present invention provides a vision system or imaging system for a vehicle that utilizes one or more cameras (preferably one or more CMOS cameras) to capture image data representative of images exterior of the vehicle, and provides enhanced pedestrian detection using classification and detection area filtering.

The vision system of the present invention includes a camera disposed at a vehicle and having a field of view exterior of the vehicle. An image processor is operable to process image data captured by the camera and, responsive to image processing of captured image data, is operable to determine the presence of a pedestrian in the field of view of said camera. The vision system utilizes a linear classifier to identify areas for further processing, and the vision system utilizes a Histogram Intersection Kernel classifier to process the identified areas while ignoring other areas. The vision system utilizes detection area filtering to reduce processing of image data representative of areas of the field of view where a pedestrian is not likely to be present.

Optionally, the camera may have a fish-eye lens and the vision system also processes captured image data to correct for lens distortion. The vision system may also utilize a Kalman filter to process the corrected image data to determine the presence of a pedestrian in the field of view of said camera.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 is a schematic showing the modules in the system of the present invention; and

FIG. 3 is a schematic showing a distance and trajectory estimation module of the system of the present invention.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a top down or bird's eye or surround view display and may provide a displayed image that is representative of the subject vehicle, and optionally with the displayed image being customized to at least partially correspond to the actual subject vehicle.

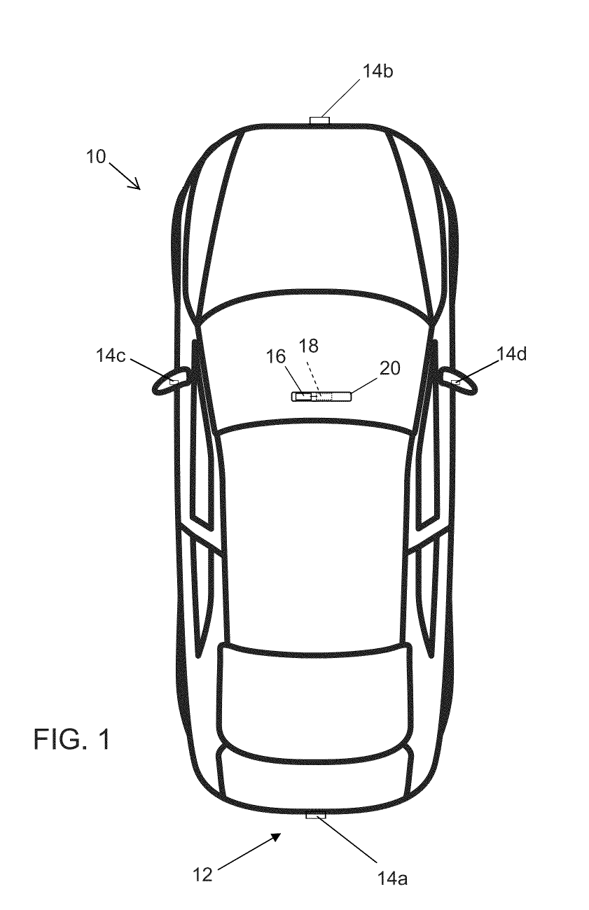

Referring now to the drawings and the illustrative embodiments depicted therein, a vehicle 10 includes an imaging system or vision system 12 that includes at least one exterior facing imaging sensor or camera, such as a rearward facing imaging sensor or camera 14a (and the system may optionally include multiple exterior facing imaging sensors or cameras, such as a forwardly facing camera 14b at the front (or at the windshield) of the vehicle, and a sidewardly/rearwardly facing camera 14c, 14d at respective sides of the vehicle), which captures images exterior of the vehicle, with the camera having a lens for focusing images at or onto an imaging array or imaging plane or imager of the camera (FIG. 1). The vision system 12 includes a control or electronic control unit (ECU) or processor 18 that is operable to process image data captured by the cameras and may provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

The purpose of the pedestrian detection (PD) system or process is to identify person(s) in the vicinity of the vehicle, especially while the vehicle is idle or moving at low speed. Thus, a positive detection of pedestrian(s) will help alert the driver for appropriate actions for safety measures.

The input images are captured by a fisheye camera. The silhouettes are in their true shapes near the middle of the image and appear a bit tilted and distorted as they move sideways.

The system of the present invention uses linear and HIK (Histogram Intersection Kernel) classifiers for finding pedestrians in the field of view of the camera or cameras. The system focuses processing on areas where pedestrians may typically be found in the field of view and ignores areas where pedestrians would not or could not be found in the field of view. The size and position of objects detected in the field of view of the camera are considered in determining whether or not the object may be a pedestrian. By focusing the processing of image data on objects and/or areas and/or features that are indicative of a pedestrian and ignoring others, the system of the present invention provides enhanced rapid pedestrian detection.

Typically, classification of the pedestrians is a computationally intensive task. For example, on a current PC, for a VGA sized input, its execution could be at about 2-4 frames per second. However, with the system of the present invention, the algorithm is executed, on the same processing hardware, at up to about 20 frames per second. All the optimizations and filters built in would also be equally beneficial during hardware implementations. The reliability of the system of the present invention, despite its higher speed, is similar to some of the latest systems being evaluated.

### Algorithm Theory and Mathematics:

The pedestrian detection system applies a cascade of linear and HIK (Histogram Intersection Kernel) classifiers for finding pedestrian(s). Linear classification is efficient in identifying positive areas for further processing. These will be verified by a more rigorous and accurate but time consuming HIK classification. Positive findings of reasonable confidence level (repeated detections of overlapping areas) will be considered.

In the exhaustive scanning through incoming image for detecting objects, a set of filtering rules, based on logical and geometric locations of a person relative to the camera, is applied to help focus on the finding areas. This filtering method also helps avoid applications of some unnecessary HIK classification steps, thus improves the overall pedestrian detection frame rate.

Applying classifiers on scanned images yield relatively fixed-size areas of positively identified objects. In order to find persons other than the pre-learned size as in classifiers, the images are sampled down (at different sizes) and then classified for finding objects of larger sizes.

These detected areas, if overlapping or one enclosed in another, will be merged and assigned confident levels (number of repeat findings). They become the detection list of the current frame.

The frame image detection list will go through an on-going process of hypothesis generation, assignment and prediction feedback loop to produce a final result list of the pedestrian detection system.

### Main Modules of the Pedestrian Detection:

### Detection Classification:

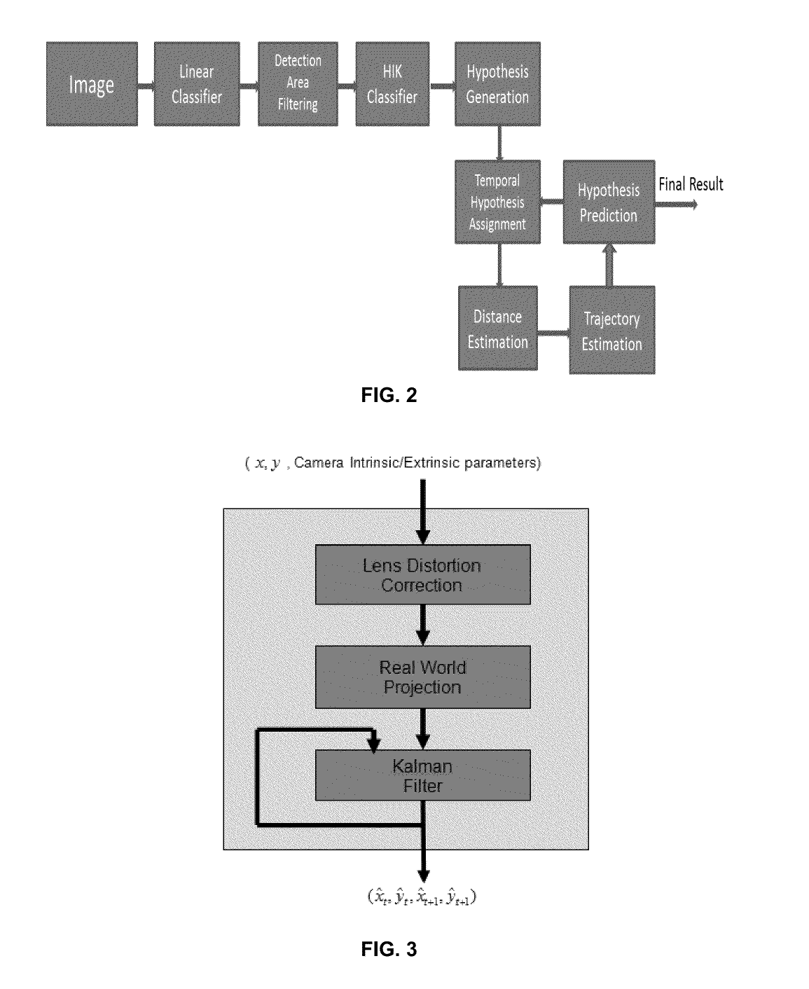

The main modules of the pedestrian detection system of the present invention are shown in FIG. 2.

Image Scaling:

A fixed area is used in scanning images for classification. Thus, a positive classification will yield a fixed sized pedestrian in an image.

The same image is also down sampled (or up sampled) for additional scanning to identify detection of a larger (or smaller) pedestrian.

Linear Classification and HIK Classification:

Each scanned area will be verified against Linear and HIK (Histogram Intersection Kernel) Classifiers.

Detection Area Filtering:

Detection Area Filtering eliminates the scanned areas where a pedestrian realistically impossible to be in. These rules include:
A determined pedestrian (or object or the like appearing to the system to be a pedestrian) seen standing above the horizon line will not be detected.
A determined pedestrian must not be taller than a maximum height or shorter than a minimum height.
A pedestrian will not be detected outside the viewing area of the camera.
No two pedestrians should be found standing one on top of another.
The considered area is outside of the region of interest (too far or too close).

Detection List Post Process:

The detection list contains positive classification areas from various levels of image scales. The list maintains, sorts, and merges these entries according to the confidence level (number of repeat findings), and area sizes.
Removes entries of lower than combine threshold required.
Removes entries of smaller size if it is completely within a larger one.
Merges any two overlapping entries into one of larger area.

### Hypotheses Evaluation:

Each entry of the detection list will be used to generate a hypothesis, based on the coordinates of the bottom center of the detection area. Multiple hypotheses that possibly belong to the same object could be combined to form a single hypothesis.

### Temporal Hypotheses Assignment:

The processed hypotheses are further evaluated using the predicted hypotheses from the previous frame. The corresponding hypotheses are assigned to the current frame where a match is found. On the other hand, if no match is found between the predicted hypothesis and the current estimated hypothesis, then a new hypothesis is initiated or provided.

If a hypothesis existed in the previous frame but is not currently detected, then this hypothesis is not immediately rejected, but is held in the memory for a specified number of frames to verify that the actually entry is no longer present. This temporal processing helps reduce false negatives when detection is missed intermittently.

### Distance and Trajectory Estimation:

Before the physical distance of the pixel locations can be estimated, the fish-eye distortion of the lens needs to be corrected. For this correction, the lens distortion is modeled as a fifth order polynomial and using this polynomial, each point in the captured image which needs further processing is un-warped.

The un-warped points used for estimating the distance of an object are the bottommost points of the objects and can be assumed to lie on the ground plane. These points can be used to estimate the distance of the objects from the camera and this distance can then be translated to the vehicle coordinates. This allows the further processing of relevant objects based on their relative distance to the vehicle.

The distance estimation of the same object across multiple frames is subject to small variations owing to real world, non-ideal conditions. Thus, these estimated distances are filtered using a Kalman filter (FIG. 3), which can smooth out the instantaneous variations. The same filter can also be used to predict the location of the object in the next frame and thus help predict the trajectory of the object.

Owing to the nature of the problem, a modified Kalman filter has been used, which has the following order of steps:
Update Step: Update the filter parameters and estimate the filtered distance of the object detected in the current frame (\hat{x}, ŷ), using the input distance (x, y).
Prediction Step: Predict the distance of the object in the next frame

### Hypothesis Prediction:

Based on the predicted physical location of the object, the location of each hypothesis in the next frame is estimated by projecting the distances back to the image plane. These projected pixel locations can then be used for the temporal assignation of the hypotheses in the next frame.

### System Output:

The object list will be output using the centroids and its bounding regions.

### Detection Area Filter Details:

### Upscale Image for Smaller Size Object Detection:

In order to detect a pedestrian of smaller size than that of scanned, upscaling the image is necessary to help detection.

### Smaller-Sized Image(s) is Considered Before the Larger One(s):

In scanning through images of various sizes, the program works on the smaller sized images before the larger ones. The pedestrian detected at a smaller image is larger compared with the one in the larger image. Thus, when scanning the larger images, the detected area will not be considered for HIK score computation if the same area has been detected before.

### Image is Scanned Bottom Up:

Scanning pedestrian detection runs from bottom to top (in a column) because the program focuses on the closest person first. Once a detection is confirmed, (with a number of repeated detections), the program will skip further upward movement on the image.

### Nan Zone:

Nan zone refers to an area on the image where the distance from the camera is infinity or cannot be calculated. This area is generally above the horizon or outside of the camera rim. The pedestrian detection system will skip over if the detection area base (center of the bottom line) is in the nan zone.

### Rim and Bumper Area:

The area below the bumper line and outside of the camera's field of view is not of interest for pedestrian detection. When scanning the image, if any corner of the detection rectangle falls in this area, the pedestrian detection system will skip this rectangle.

### Lowest Curve:

When projecting the minimum height required object at the closest distance to the camera, a curve can be drawn across the image as the border line. The pedestrian detection system will consider the detection area whose top (middle point of the top line) is above this line only.

If the camera height is equal to or lower than the object's minimum height, then the lowest curve coincides with the horizon line. In this special case, all object top lines must be above the horizon line.

### Adaptive Working Area Per Image Scale Level:

Because the scanning size is constant throughout all image scale levels, the scanning region of the image also varies per scale level. The start line begins at the horizon line plus a scanning height toward the top, or the start line of image, whichever value is larger. The end line is defined as the bumper line plus the height of scanning size toward the bottom of the image, or the image bottom, whichever value is smaller.

By applying the different start and end lines on the image per scale level, the pedestrian detection process or system uses variable working regions, enough to help reduce complex computations of Sobel and integral images. This application is especially useful at the larger size images where a large number of computations can be saved.

Thus, the vision system of the present invention comprises a camera configured to be disposed at a vehicle so as to have a field of view exterior of the vehicle, with an image processor operable to process image data captured by the camera. The image processor, responsive to image processing of captured image data and with the camera disposed at the vehicle, is operable to determine the presence of a pedestrian in the field of view of the camera. The vision system may utilize a linear classifier to identify areas for further processing of areas where a pedestrian is likely to be present, and the image processor enhances processing of captured image data representative of the identified areas. The vision system may utilize a Histogram Intersection Kernel classifier to enhance processing of the identified areas or areas where a pedestrian is likely to be present. The vision system may also utilize a Kalman filter to process the corrected image data to determine the presence of a pedestrian in the field of view of the camera.

Optionally, the vision system may utilize at least one of (i) a distance estimation algorithm and (ii) a trajectory estimation algorithm. Optionally, when processing captured frames of image data of various sizes, the vision system may process image data of smaller frames before processing image data of larger frames. Optionally, the image processor may process captured image data from a bottom of the frame to a top of the frame to determine a pedestrian that is closest to the vehicle first, and, responsive to detection of a pedestrian, the system then does not process image data above the detected pedestrian.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an EyeQ2 or EyeQ3 image processing chip available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, which are all hereby incorporated herein by reference in their entireties. The system may communicate with other communication systems via any suitable means, such as by utilizing aspects of the systems described in International Publication Nos. WO/2010/144900; WO 2013/043661 and/or WO 2013/081985, and/or U.S. Pat. No. 9,126,525, which are hereby incorporated herein by reference in their entireties.

The imaging device and control and image processor and any associated illumination source, if applicable, may comprise any suitable components, and may utilize aspects of the cameras and vision systems described in U.S. Pat. Nos. 5,550,677; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454 and/or 6,824,281, and/or International Publication Nos. WO 2010/099416; WO 2011/028686 and/or WO 2013/016409, and/or U.S. Pat. Publication No. US 2010-0020170, which are all hereby incorporated herein by reference in their entireties. The camera or cameras may comprise any suitable cameras or imaging sensors or camera modules, and may utilize aspects of the cameras or sensors described in U.S. Publication No. US-2009-0244361 and/or U.S. Pat. Nos. 8,542,451; 7,965,336 and/or 7,480,149, which are hereby incorporated herein by reference in their entireties. The imaging array sensor may comprise any suitable sensor, and may utilize various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 5,715,093; 5,877,897; 6,922,292; 6,757,109; 6,717,610; 6,590,719; 6,201,642; 6,498,620; 5,796,094; 6,097,023; 6,320,176; 6,559,435; 6,831,261; 6,806,452; 6,396,397; 6,822,563; 6,946,978; 7,339,149; 7,038,577; 7,004,606; 7,720,580 and/or 7,965,336, and/or International Publication Nos. WO/2009/036176 and/or WO/2009/046268, which are all hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149 and/or 7,526,103, which are all hereby incorporated herein by reference in their entireties, a rain sensor, such as the types disclosed in commonly assigned U.S. Pat. Nos. 6,353,392; 6,313,454; 6,320,176 and/or 7,480,149, which are hereby incorporated herein by reference in their entireties, a vehicle vision system, such as a forwardly, sidewardly or rearwardly directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978 and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,881,496; 7,720,580; 7,038,577; 5,929,786 and/or 5,786,772, which are hereby incorporated herein by reference in their entireties, a video device for internal cabin surveillance and/or video telephone function, such as disclosed in U.S. Pat. Nos. 5,760,962; 5,877,897; 6,690,268 and/or 7,370,983, and/or U.S. Publication No. US-2006-0050018, which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

Optionally, the circuit board or chip may include circuitry for the imaging array sensor and or other electronic accessories or features, such as by utilizing compass-on-a-chip or EC driver-on-a-chip technology and aspects such as described in U.S. Pat. Nos. 7,255,451 and/or 7,480,149 and/or U.S. Publication Nos. US-2006-0061008 and/or US-2010-0097469, which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device disposed at or in the interior rearview mirror assembly of the vehicle, such as by utilizing aspects of the video mirror display systems described in U.S. Pat. No. 6,690,268 and/or U.S. Publication No. US-2012-0162427, which are hereby incorporated herein by reference in their entireties. The video mirror display may comprise any suitable devices and systems and optionally may utilize aspects of the compass display systems described in U.S. Pat. Nos. 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252 and/or 6,642,851, and/or European patent application, published Oct. 11, 2000 under Publication No. EP 0 1043566, and/or U.S. Publication No. US-2006-0061008, which are all hereby incorporated herein by reference in their entireties. Optionally, the video mirror display screen or device may be operable to display images captured by a rearward viewing camera of the vehicle during a reversing maneuver of the vehicle (such as responsive to the vehicle gear actuator being placed in a reverse gear position or the like) to assist the driver in backing up the vehicle, and optionally may be operable to display the compass heading or directional heading character or icon when the vehicle is not undertaking a reversing maneuver, such as when the vehicle is being driven in a forward direction along a road (such as by utilizing aspects of the display system described in International Publication No. WO 2012/051500, which is hereby incorporated herein by reference in its entirety).

Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vision system of a vehicle, said vision system comprising:
a camera configured to be disposed at a vehicle so as to have a field of view exterior of the vehicle;
wherein said camera comprises a pixelated imaging array having a plurality of photosensing elements;
an image processor operable to process image data captured by said camera;
wherein said image processor, responsive to image processing of captured image data and with said camera disposed at the vehicle, is operable to determine the presence of a pedestrian in the field of view of said camera; and
wherein said vision system utilizes a linear classifier to identify areas for further processing of areas where a pedestrian is likely to be present, and wherein said image processor enhances processing of captured image data representative of the identified areas.

2. The vision system of claim 1, wherein said vision system utilizes a Histogram Intersection Kernel classifier to enhance processing of the identified areas.

3. The vision system of claim 1, wherein said vision system utilizes detection area filtering to reduce processing of image data representative of areas of the field of view where a pedestrian is not likely to be present.

4. The vision system of claim 1, wherein said camera comprises a fish-eye lens and wherein said vision system processes captured image data to correct for lens distortion.

5. The vision system of claim 4, wherein said vision system utilizes a Kalman filter to process the corrected image data to determine the presence of a pedestrian in the field of view of said camera.

6. The vision system of claim 1, wherein said vision system utilizes at least one of (i) a distance estimation algorithm and (ii) a trajectory estimation algorithm.

7. The vision system of claim 1, wherein, when processing captured frames of image data of various sizes, said vision system processes image data of smaller frames before processing image data of larger frames.

8. The vision system of claim 1, wherein said image processor processes captured image data from a bottom of the frame to a top of the frame to determine a pedestrian that is closest to the vehicle first.

9. The vision system of claim 8, wherein, responsive to detection of a pedestrian, said system does not process image data above the detected pedestrian.

10. A vision system of a vehicle, said vision system comprising:
a camera configured to be disposed at a vehicle so as to have a field of view exterior of the vehicle;
wherein said camera comprises a pixelated imaging array having a plurality of photosensing elements;
an image processor operable to process image data captured by said camera;
wherein said image processor, responsive to image processing of captured image data and with said camera disposed at the vehicle, is operable to determine the presence of a pedestrian in the field of view of said camera; and
wherein said vision system utilizes a Histogram Intersection Kernel classifier to enhance processing of areas where a pedestrian is likely to be present.

11. The vision system of claim 10, wherein said vision system utilizes detection area filtering to reduce processing of image data representative of areas of the field of view where a pedestrian is not likely to be present.

12. The vision system of claim 10, wherein said camera comprises a fish-eye lens and wherein said vision system processes captured image data to correct for lens distortion.

13. The vision system of claim 12, wherein said vision system utilizes a Kalman filter to process the corrected image data to determine the presence of a pedestrian in the field of view of said camera.

14. The vision system of claim 13, wherein said vision system utilizes at least one of (i) a distance estimation algorithm and (ii) a trajectory estimation algorithm.

15. The vision system of claim 10, wherein said vision system utilizes at least one of (i) a distance estimation algorithm and (ii) a trajectory estimation algorithm.

16. A vision system of a vehicle, said vision system comprising:
a camera configured to be disposed at a vehicle so as to have a field of view exterior of the vehicle;
wherein said camera comprises a pixelated imaging array having a plurality of photosensing elements;
an image processor operable to process image data captured by said camera;
wherein said image processor, responsive to image processing of captured image data and with said camera disposed at the vehicle, is operable to determine the presence of a pedestrian in the field of view of said camera;
wherein said vision system utilizes a linear classifier to identify areas for further processing of areas where a pedestrian is likely to be present;
wherein said vision system utilizes a Histogram Intersection Kernel classifier to enhance processing of captured image data representative of the identified areas; and
wherein said vision system utilizes at least one of (i) a distance estimation algorithm and (ii) a trajectory estimation algorithm.

17. The vision system of claim 16, wherein said vision system utilizes detection area filtering to reduce processing of image data representative of areas of the field of view where a pedestrian is not likely to be present.

18. The vision system of claim 16, wherein said camera comprises a fish-eye lens and wherein said vision system processes captured image data to correct for lens distortion.

19. The vision system of claim 16, wherein said vision system utilizes a Kalman filter to process the corrected image data to determine the presence of a pedestrian in the field of view of said camera.

20. The vision system of claim 16, wherein said image processor processes captured image data from a bottom of the frame to a top of the frame to determine a pedestrian that is closest to the vehicle first, and wherein, responsive to detection of a pedestrian, said system does not process image data above the detected pedestrian.
